(19) United States
(12) Patent Application Publication
(10) Pub. No.: US 2025/0336398 A1
(43) Pub. Date: Oct. 30, 2025

(54) METHOD FOR INFORMATION INTERACTION AND APPARATUS, DEVICE AND STORAGE MEDIUM

(71) Applicant: Beijing Zitiao Network Technology Co., Ltd., Beijing (CN)

(72) Inventors: Weize ZHAO, Beijing (CN); Yu Jiang, Beijing (CN); Qi Zhang, Beijing (CN); Shuaixiang Jin, Beijing (CN); Guanghan Zhang, Beijing (CN)

(21) Appl. No.: 19/084,669

(22) Filed: Mar. 19, 2025

(30) Foreign Application Priority Data
Apr. 25, 2024 (CN) 202410509955.3

(51) Int. Cl. G10L 15/22; G06F 16/3332; H04L 12/18

(52) U.S. Cl. CPC G10L 15/22; G06F 16/3334; H04L 12/1831

(57) ABSTRACT

The embodiment of the invention provides a method for information interaction and apparatus, device, and a storage medium. The method includes: receiving an access instruction for a digital assistant to access a real-time interactive scenario on behalf of a user; creating, in response to the access instruction, a target session for the real-time interactive scenario, members of the target session comprising the user and the digital assistant; and presenting, during the real-time interactive scenario, interaction progress information of the real-time interactive scenario through the target session. In this manner, in a case that the user accesses the real-time interactive scenario without audio and video, the user may also obtain the interaction status in time.

### CROSS-REFERENCE

This application claims priority to Chinese Patent Application No. 202410509955.3, filed on Apr. 25, 2024, entitled “METHOD FOR INFORMATION INTERACTION AND APPARATUS, DEVICE AND STORAGE MEDIUM”, the disclosure of which is incorporated herein by reference in its entirety.

### FIELD

Example embodiments of the present disclosure generally relate to the field of computers, and in particular, to a method, apparatus, device, and computer-readable storage medium for information interaction.

### BACKGROUND

With the development of information technologies, various terminal devices may provide various services to people in work and life. Applications providing services may be deployed in terminal devices. Terminal devices or applications may provide users with digital assistant functions to users in using terminal devices or applications. How to enable digital assistants to provide users with more services is a technical problem that needs to be explored at present.

### SUMMARY

In a first aspect of the present disclosure, a method for information interaction is provided. The method includes: receiving an access instruction for a digital assistant to access a real-time interactive scenario on behalf of a user; creating, in response to the access instruction, a target session for the real-time interactive scenario, members of the target session comprising the user and the digital assistant; and presenting, during the real-time interactive scenario, interaction progress information of the real-time interactive scenario through the target session.

In a second aspect of the present disclosure, an apparatus for information interaction is provided. The device comprises an indication receiving module, a session creation module and an information presentation module, where the indication receiving module is configured to receive an access instruction for a digital assistant to access a real-time interactive scenario on behalf of a user; the session creation module is configured to create, in response to the access instruction, a target session for the real-time interactive scenario, members of the target session comprising the user and the digital assistant; and the information presentation module is configured to present during the real-time interactive scenario, interaction progress information of the real-time interactive scenario through the target session.

In a third aspect of the present disclosure, an electronic device is provided. The apparatus includes at least one processing unit; and at least one memory coupled to the at least one processing unit and storing instructions for execution by the at least one processing unit. The instructions, when executed by the at least one processing unit, cause the device to perform the method of the first aspect.

In a fourth aspect of the present disclosure, a computer-readable storage medium is provided. The computer-readable storage medium stores a computer program, and the computer program is executable by the processor to implement the method of the first aspect.

It should be understood that the content described in this content section is not intended to limit the key features or important features of the embodiments in the present disclosure, nor is it intended to limit the scope of the present disclosure. Other features of the present disclosure will become readily understood from the following description.

### BRIEF DESCRIPTION OF DRA WINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

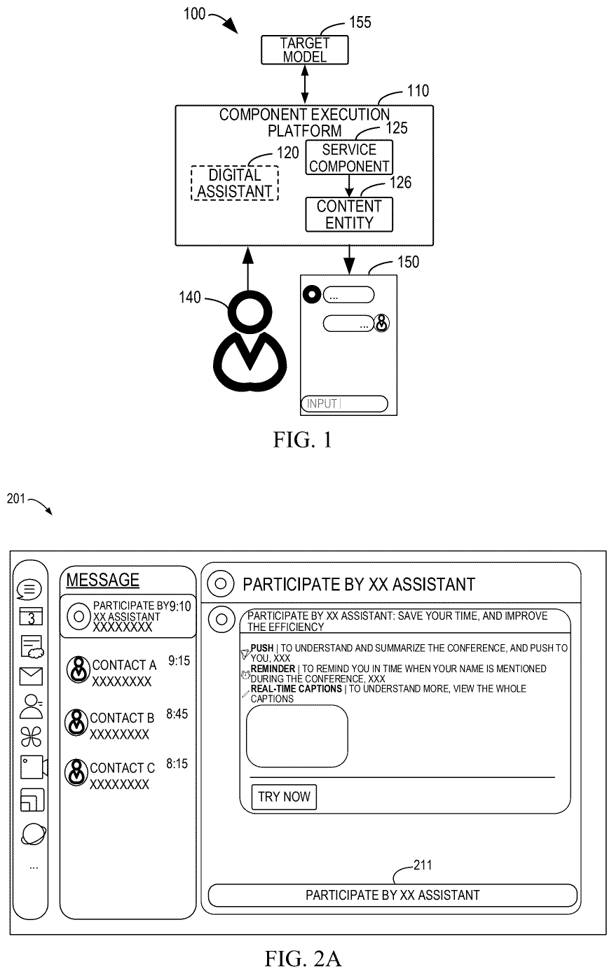

FIG. 1 illustrates a schematic diagram of an example environment in which embodiments of the present disclosure may be implemented;

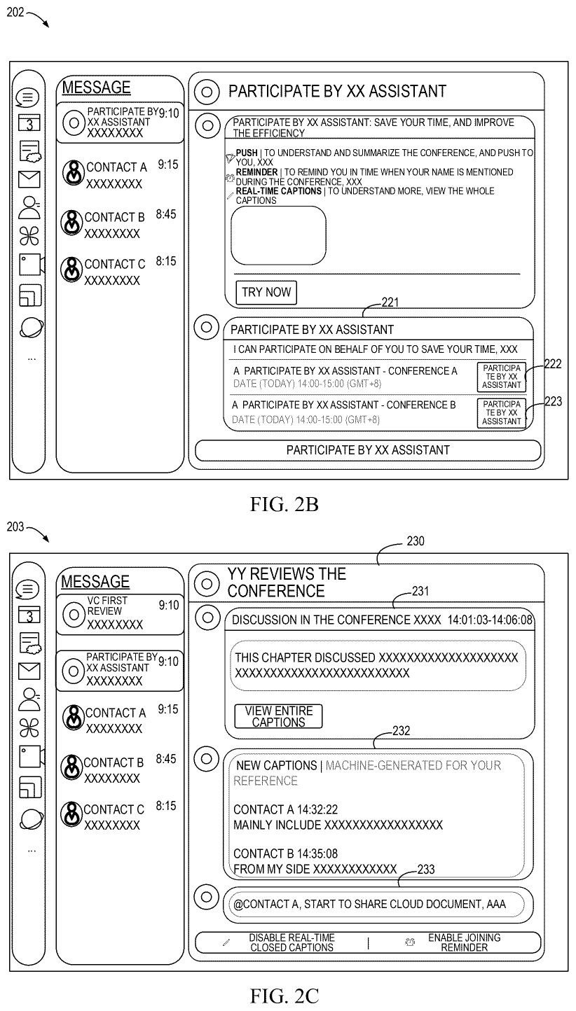

FIG. 2A to FIG. 2E are schematic diagrams of example interfaces of a digital assistant accessing a real-time interactive scenario on behalf of a user according to some embodiments of the present disclosure;

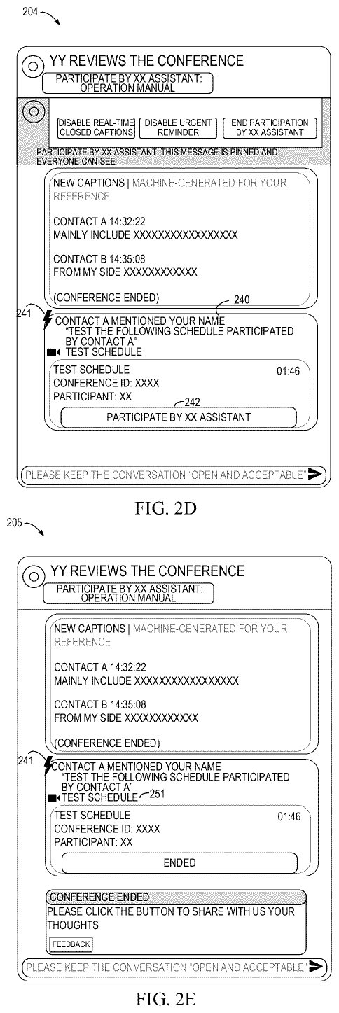

FIG. 3 illustrates a schematic diagram of an example architecture for a digital assistant to obtain historical speech content in a real-time interactive scenario according to some embodiments of the present disclosure;

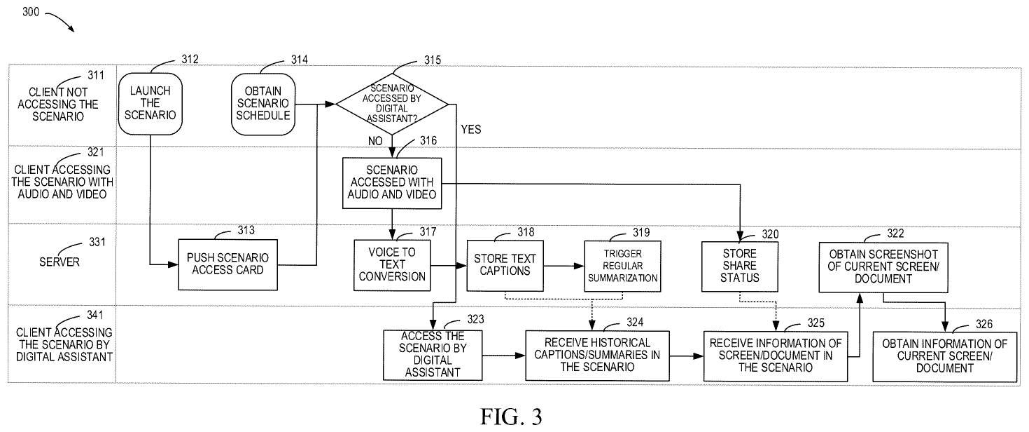

FIG. 4 illustrates a schematic diagram of an example architecture for a digital assistant to obtain real-time speech content in a real-time interactive scenario according to some embodiments of the present disclosure;

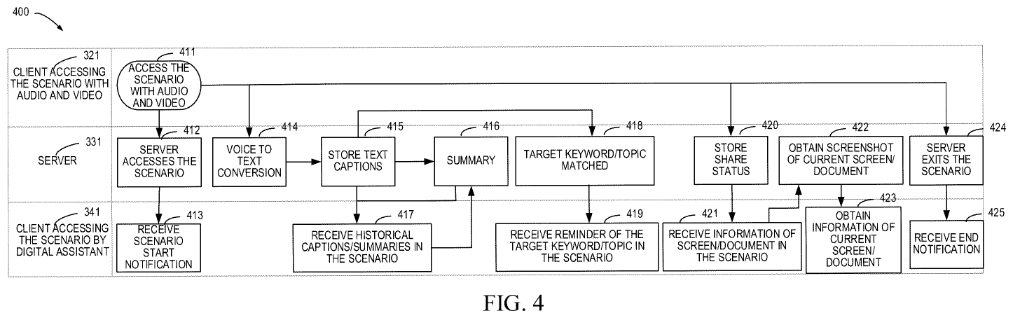

FIG. 5 illustrates a schematic diagram of an example architecture for detecting whether an interaction in a real-time interactive scenario satisfies a preconfigured condition according to some embodiments of the present disclosure;

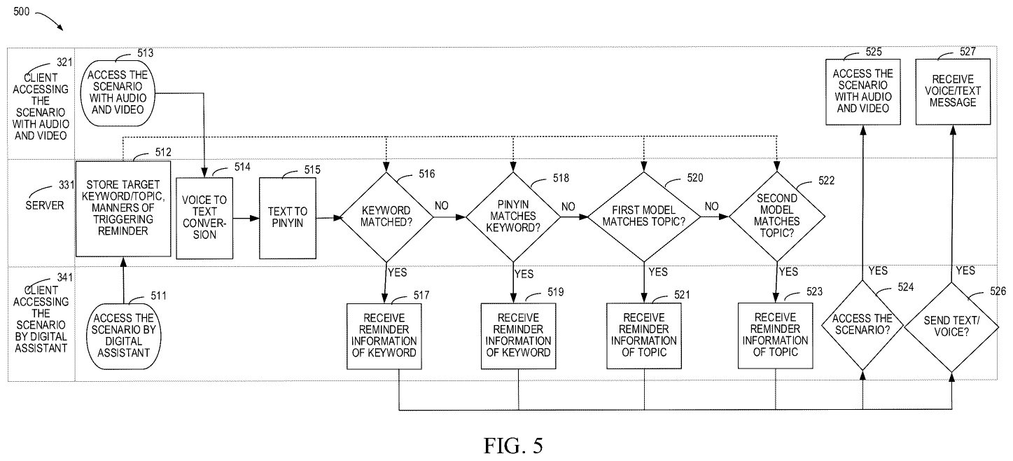

FIG. 6 shows a flowchart of a process for information interaction according to some embodiments of the present disclosure;

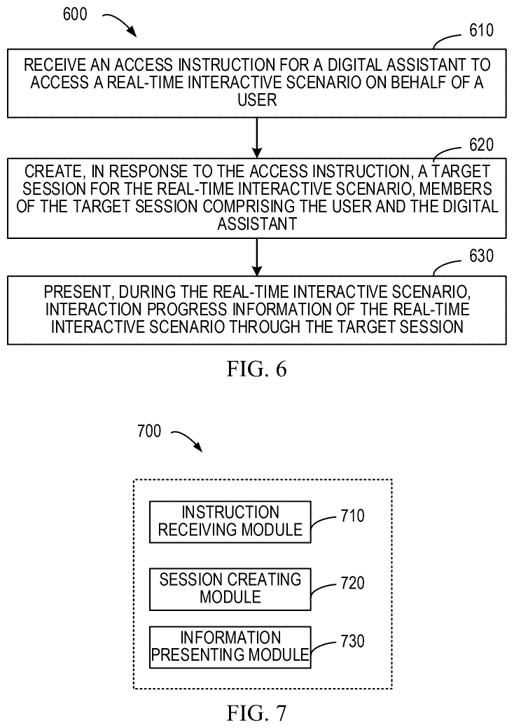

FIG. 7 illustrates a schematic structural block diagram of an apparatus for information interaction according to some embodiments of the present disclosure; and

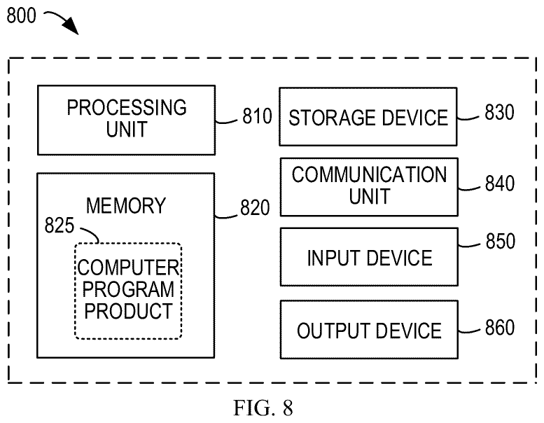

FIG. 8 illustrates a block diagram of a device capable of implementing various embodiments of the present disclosure.

### DETAILED DESCRIPTION

It may be understood that, before the technical solutions disclosed in the embodiments of the present disclosure are used, the types of personal information related to the present disclosure, the usage scope, the usage scenario and the like should be notified to the user in an appropriate manner according to the relevant laws and regulations and obtain the authorization of the user.

For example, in response to receiving an active request from a user, prompt information is sent to the user to explicitly prompt the user that the requested operation will need to acquire and use the personal information of the user. Therefore, the user may autonomously select whether to provide personal information to software or hardware executing the operation of the technical solution of the present disclosure according to the prompt information.

As an optional but non-limiting implementation, in response to receiving the active request of the user, the manner of sending the prompt information to the user may be, for example, a pop-up window, and the prompt information may be presented in a text manner in the pop-up window. In addition, the pop-up window may further carry a selection control for the user to select “agree” or “not agree” to provide personal information to the electronic device.

It may be understood that the foregoing notification and obtaining a user authorization process is merely illustrative and does not constitute a limitation on implementations of the present disclosure, and other manners of conference related laws and regulations may also be applied to implementations of the present disclosure.

It may be understood that the data involved in the technical solution (including but not limited to the data itself, the acquisition or use of the data) should follow the requirements of the corresponding laws and regulations and related regulations.

Embodiments of the present disclosure will be described in more detail below with reference to the accompanying drawings. While certain embodiments of the present disclosure are shown in the accompanying drawings, it should be understood that the present disclosure may be implemented in various forms and should not be construed as limited to the embodiments set forth herein, but rather, these embodiments are provided for a more thorough and complete understanding of the present disclosure. It should be understood that the drawings and embodiments of the present disclosure are for exemplary purposes only and are not intended to limit the scope of the present disclosure.

It should be noted that the title of any section/subsection provided herein is not limiting. Various embodiments are described throughout, and any type of embodiments may be included in any section/subsection. Furthermore, the embodiments described in any section/subsection may be combined in any manner with the same section/subsection and/or any other embodiment described in different sections/subsections.

Herein, unless explicitly stated, “responding to A” performs one step and does not imply that this step is performed immediately after “A” but may include one or more intermediate steps.

In the description of the embodiments of the present disclosure, the terms “including”, and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

As used herein, the term “model” may learn associations between respective inputs and outputs from training data such that corresponding outputs may be generated for a given input after training is complete. The generation of the model may be based on machine learning techniques. Deep learning is a machine learning algorithm that processes inputs and provides corresponding outputs by using a multi-layer processing unit. “Model” may also be referred to herein as a “machine learning model,” “machine learning network,” or “network,” which terms are used interchangeably herein. A model may in turn include different types of processing units or networks.

### Example Environment

FIG. 1 illustrates a schematic diagram of an example environment 100 in which embodiments of the present disclosure may be implemented. In this example environment 100, a component execution platform 110 may support the operation of a service component 125. User 140 may interact via a client and the service component 125 of the component execution platform 110.

In some embodiments, the service component 125 may be downloaded, installed on a terminal device of the user 140. In some embodiments, the service component 125 may also be accessed in other manners, for example, through a webpage access. In the environment 100 of FIG. 1, in response to the launch of the service component 125, a client of the component execution platform 110 may present interface 150 of the service component 125.

The service component 125 includes, but is not limited to, one or more of the following: a chat service component (also referred to as an instant messaging service (IM) component), a document service component, an audio and video conference service component, a mail service component, a task service component, a calendar service component, an object and key result (OKR) service component, and the like. It may be understood that although a single service component is shown in FIG. 1, in practice, multiple service components may be installed on the terminal device. Multiple service components may be integrated on the component execution platform 110, which may be considered as a multifunction collaboration platform. When multiple service components are installed on the terminal device, the multiple service components may be integrated on one or more component execution platforms 110. On the component execution platform 110, people may start different service components according to their needs to process, share, communicate corresponding information and the like. The service component 125 may provide a content entity 126. The content entity 126 may be an instance of the content created by user 140 or other users on the service component 125. For example, depending on the type of the service component 125, the content entity 126 may be a document (e.g., a word document, a pdf document, a presentation, a tabular document, etc.), a mail, a message (e.g., a session message on the instant messaging service component), a calendar, a schedule, a task, an audio, a video, an image, or the like.

Although FIG. 1 illustrates one user 140, there may be multiple such users 140 and corresponding terminal devices. These users 140 may interact with the service component 125 via their own terminal devices, respectively. The service component 125 may provide real-time interactive scenarios, such as online conferences, real-time streaming, etc., for these users 140. In this real-time interactive scenario, one or more speaking parties may interact with each other through corresponding speech content.

Herein, a speaking party in a real-time interactive scenario may refer to an entity sending a voice message in the real-time interactive scenario. For example, if the real-time interactive scenario is an online conference, the speaking party may be a participant of the conference. In some embodiments, the speaking party may include multiple speakers, for example, such speaking party may be determined from the terminals participating in the online conference. For example, if multiple conference participants may access the online conference through the same terminal (or using the same account), such multiple participants may be identified as the same speaking party, although it may include multiple different speakers. Alternatively, or additionally, in some embodiments, one speaking party may correspond to one speaker. It should be understood that any suitable speaking party recognition technology may be used to determine the speaking party in the real-time interactive scenario, which is not intended to be limited in the present disclosure.

In some embodiments, the component execution platform 110 may provide a digital assistant 120. The digital assistant 120 may be provided by a separate service component or integrated in a certain service component 120 capable of providing a content entity. A service component for providing a client interface of the digital assistant may correspond to a single function service component or to a multifunction collaboration platform, such as an office suite or other collaboration platform capable of integrating multiple components. It will be appreciated that although a single digital assistant is shown in FIG. 1, multiple digital assistants may actually be present, similar to the service component.

In some embodiments, the digital assistant 120 supports the use of plugins. Each plug-in may provide one or more functions of the service component. Such plug-ins include, but are not limited to, one or more of a search plug-in, a contact plug-in, a message plug-in, a document plug-in, a table plug-in, a mail plug-in, a calendar plug-in, a schedule plug-in, a task plug-in, and the like.

The digital assistant 120 may be an intelligent assistant of a user and with intelligent dialogue and information processing capabilities. In an embodiment of the present disclosure, the digital assistant 120 is configured to interact with the user 140 to assist the user 140 in using the terminal device or the service component. An interaction window with the digital assistant 120 may be presented in the client interface. In the interaction window, the user 140 may interact with the digital assistant 120 by inputting a natural language, a picture, an audio file, a video file, a web page file, etc., to instruct the digital assistant to assist in completing various tasks, including operations on the content entity 126.

In some embodiments, the digital assistant 120 may be included as a contact of the user 140, in a contact list of the current user 140 in the office suite, or in the information flow of the chat component. In some embodiments, there is a corresponding relationship of the user 140 with the digital assistant 120. For example, a first digital assistant corresponds to the first user, a second digital assistant corresponds to the second user, and so on. In some embodiments, the first digital assistant may uniquely correspond to the first user, the second digital assistant may uniquely correspond to the second user, and so on. That is, the first digital assistant of the first user may be specific or dedicated to the first user. For example, in a process in which the first digital assistant provides assistance or service for the first user, the first digital assistant may utilize its historical interaction information with the first user, the data authorized by the first user that it may access, the current interaction context of the first digital assistant with the first user, and the like. If the first user is an individual or a person, the first digital assistant may be considered as a personal digital assistant. It may be understood that, in the disclosed embodiment, the first digital assistant is based on the authorized access to the data to which the permission is granted by the first user. It should be understood that the “uniquely corresponding” or the like in this disclosure is not intended to limit the first digital assistant to be updated accordingly based on the interaction process between the first user and the first digital assistant. Of course, the digital assistant 120 does not have to be specific to the current user 140, but may be a universal digital assistant, depending on the actual needs.

In some embodiments, multiple interaction modes between the user 140 and the digital assistant 120 may be provided and may be flexibly switched among the multiple interaction modes. In the event that a certain interaction mode is triggered, a corresponding interaction area is presented to facilitate interaction of the user 140 with the digital assistant 120. The interaction manners of the user 140 and the digital assistant 120 in different interaction modes are different, which may flexibly adapt to interaction requirements in different scenarios.

In some embodiments, an information handling service specific to the user 140 may be provided based on the historical interaction information of the user 140 with the digital assistant 120 and/or a data range specific to the user 140. In some embodiments, the respective historical interaction information that the user 140 interacts with the digital assistant 120 in the plurality of interaction modes may be stored in association with the user 140. As such, in one of the plurality of interaction modes (either or a designated interaction mode), the digital assistant 120 may provide services to the user 140 based on the historical interaction information stored in association with the user 140.

The digital assistant 120 may be invoked or waken up in an appropriate manner (e.g., shortcut, button, or voice) to present an interaction window with the user 140. By selecting the digital assistant 120, an interaction window with the digital assistant 120 may be opened. The interaction window may include an interface element for information interaction, such as an input box, a message list, a message bubble, and the like. In some other embodiments, the digital assistant 120 may be invoked through an entry control or a menu provided in the page, or by inputting a preconfigured instruction.

The interaction window of the digital assistant 120 and the user 140 may include a session window, for example, a session window in an instant messaging service component or an instant messaging module of the target service component. In the session window, the interaction between the digital assistant 120 and the user 140 may be presented in the form of a session message. Alternatively, or additionally, the interaction window of the digital assistant 120 and the user 140 may further include other types of windows, such as a window in a floating window mode, where the user 140 may trigger the digital assistant 120 to perform a corresponding operation by inputting an instruction, selecting a shortcut instruction, or the like.

In some embodiments, the digital assistant 120 may support an interaction mode of a session window, also referred to as a conversation mode. In this interaction mode, a session window of the user 140 and the digital assistant 120 is presented, and the user 140 interacts with the digital assistant 120 through session messages in the session window. In the conversation mode, the digital assistant 120 may perform tasks according to session messages in the session window. In the interaction window, the user 140 enters an interaction message, and the digital assistant 120 provides a reply message in response to the user input.

In some embodiments, the conversation mode of the user 140 and the digital assistant 120 may be invoked or waken up in an appropriate manner (e.g., shortcut, button, or voice) to present the session window. By selecting the digital assistant 120, the session window with the digital assistant 120 may be opened. The session window may include interface elements for information interaction, such as input boxes, message lists, message bubbles, and the like.

In some embodiments, the digital assistant 120 may support a floating window (or window-floating) interaction mode, also referred to as a floating window mode. In the event that the floating window mode is triggered, an operation panel (also referred to as a floating window) corresponding to the digital assistant 120 is presented, and the user 140 may issue an instruction to the digital assistant 120 based on the operation panel. In some embodiments, the operation panel may include at least one candidate shortcut instruction. Alternatively, or additionally, the operation panel may include an input control for receiving instructions. In the floating window mode, the digital assistant 120 may perform tasks according to instructions sent by the user 140 through the operation panel.

In some embodiments, the floating window mode of the user 140 and the digital assistant 120 may also be invoked or waken up in an appropriate manner (for example, shortcut, button, or voice) to present the corresponding operation panel. In some embodiments, waking-up of the digital assistant 120 may be supported in a particular service component, such as in the document service component, to provide interaction in the floating window mode. In some embodiments, to trigger the floating window mode to present the operation panel corresponding to the digital assistant 120, an entry control for the digital assistant 120 may be presented in the service component interface. In response to detecting the trigger for the entry control, it may be determined that the floating window mode is triggered and the operation panel corresponding to the digital assistant 120 is presented in the target interface region.

In some embodiments described below, for ease of discussion, the interaction window of the user and the digital assistant is mainly used as an example for description.

The component execution platform 110 may be deployed locally on the terminal device of each user 140, and/or may be supported by a server device. For example, the terminal device of the user 140 may run a client of the component execution platform 110, and the client may support interaction between the user 140 and the component execution platform 110 provided by the server. When the component execution platform 110 runs on the user's terminal device, the user 145 may directly interact with the local component execution platform 110 using the terminal device. When the component execution platform 110 runs at the server device, the server device may implement service provisioning for the client running in the terminal device based on the communication connection with the terminal device. The component execution platform 110 may present respective interfaces 150 to the user 140 based on the operations of the user 140 to output to and/or receive from the user 140, information related to the usage of the component.

In some embodiments, implementation of at least partial functionality of the service component 125, and/or implementation of at least partial functionality of the digital assistant 120 may be implemented based on a target model. During the operation of the service component 125, one or more target models 155 may be invoked. The user input may be understood by the target model 155 and provided based on the output of the target model 155, such as providing a reply to the user.

Although shown as independent of the component execution platform 110, one or more target models 155 may run on the component execution platform 110, or other remote servers. In some embodiments, the target model 155 may be a machine learning model, a deep learning model, a learning model, a neural network, or the like. In some embodiments, the model may be based on a language model (LM). The language model may have question-answering capabilities by learning from a large amount of corpus. The target model 155 may also be based on other suitable models.

The component execution platform 110 may run on a suitable electronic device. The electronic device herein may be any type of device having computing capabilities, including a terminal device or a server device. The terminal device may be any type of mobile terminal, fixed terminal, or portable terminal, including a mobile handset, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a pointing device, a television receiver, a radio broadcast receiver, an e-book device, a gaming device, or any combination of the foregoing, including accessories and peripherals of these devices, or any combination thereof. The server device may include, for example, a computing system/server, such as a mainframe, an edge computing node, a computing device in a cloud environment, or the like. In some embodiments, the component execution platform 110 may be implemented based on cloud services.

It should be understood that the structure and function of the environment 100 is described for illustrative purposes only and does not imply any limitation to the scope of the present disclosure.

At present, for a user participating in a real-time interactive scenario (for example, a user attending a conference), the user needs to participate in the real-time interactive scenario through audio and video. Audio and video participation in the real-time interactive scenario (also referred to as an audio/video mode) means that the user needs to participate in the conference through an audio and video output/input device such as a microphone, a camera, and a speaker. The user sends video data through the camera, sends the audio data through the microphone, and plays the audio data through the speaker.

However, the participance in an audio and video mode needs to be in the whole process, and if only a specific topic is interested, it is still necessary to participate for a long time. Correspondingly, the audio and video mode may have a certain requirement on the network, and in the case of poor signal, the experience is very poor. Further, the participance in an audio and video mode may be only for one conference at a time and may not obtain historical content of the conference in case of joining halfway.

In order to at least partially solve one or more of the above problems, embodiments of the present disclosure provide a solution for information interaction. According to various embodiments of the present disclosure, an access instruction used by a digital assistant to access a real-time interactive scenario on behalf of a user is received; in response to the access instruction, a target session for the real-time interactive scenario is created, and the user and the digital assistant are members of the target session; and during the real-time interactive scenario, interactive progress information of the real-time interactive scenario is presented through the target session. Such interaction progress information may include any suitable graphic and textual information.

In this manner, the user may select to access the real-time interactive scenario (for example, the conference) by the digital assistant according to the requirement without the need to access in the audio and video manner. In this manner, in a case where the user accesses the real-time interactive scenario without audio and video, the user may also obtain the interaction status in time. In the following description, this manner of accessing the real-time interactive scenario by the digital assistant is also referred to as an assistant mode or an image-text mode.

Some example embodiments of the present disclosure will be described below with continued reference to the accompanying drawings. It should be understood that the pages shown in the drawings are merely examples, and there may be various page designs. There may be different arrangements and different visual representations for respective graphical elements in the page, one or more of which may be omitted or replaced, and there may also one or more other elements. Embodiments of the present disclosure are not limited in this respect. Further, in the following, example embodiments will be described primarily with respect to the component execution platform 110. It should be understood that the actions described with respect to the component execution platform 110 may be performed by an application, a component, or a suite on the component execution platform 110 (e.g., the service component 125), or by an application, a component, or a suite in conjunction with its server end (e.g., server). In addition, for ease of discussion, the conference is described as an example of a real-time interactive scenario, but this is merely illustrative, which is not limited in the present disclosure.

### Example Interaction

The following describes a solution for information interaction in the present disclosure with reference to FIG. 2A to FIG. 5. FIG. 2A to FIG. 2E are schematic diagrams of example interfaces 201 to 205 of a digital assistant accessing a real-time interactive scenario on behalf of a user according to some embodiments of the present disclosure.

In some embodiments, the component execution platform 110 receives an access instruction for a digital assistant to access a real-time interactive scenario on behalf of a user. If the user 140 selects the digital assistant to participate in the real-time interactive scenario on his/her behalf, the component execution platform 110 receives an access instruction for the digital assistant to participate in the real-time interactive scenario on behalf of the user 140.

In some embodiments, the component execution platform 110 may receive the access instruction via a start message for the real-time interactive scenario. When the real-time interactive scenario is started (for example, the start of a conference), the component execution platform 110 may present a start message for the real-time interactive scenario in the form of a launch card. The component execution platform 110 receives an access instruction based on the launch card.

For example, when the real-time interactive scenario is started, the component execution platform 110 pops up a card corresponding to the real-time interactive scenario in the form of a pop-up window. The component execution platform 110 will present a corresponding control of the “participate by XX assistant” on the card, and the user 140 may click the control to enable the XX assistant to participate the real-time interactive scenario on behalf of the use 140.

Alternatively, or additionally, in some embodiments, the component execution platform 110 may receive the access instruction via access invitation information for the real-time interactive scenario. In some examples, the component execution platform 110 may receive an access instruction in the session of user 140 with the invitee, or the session of user 140 with the calendar assistant.

For example, in the session of the user 140 with the invitee or the session of the user 140 with the calendar assistant, the component execution platform 110 presents the access invitation information from the invitee or the calendar helper for the real-time interactive scenario. The component execution platform 110 may present a corresponding control of the “participate by XX assistant” on the invitation information, and the user 140 may click the control, so that the XX assistant replaces the user 140 with reference to the real-time interactive scenario.

Alternatively, or additionally, in some embodiments, the component execution platform 110 may receive the access instruction via a schedule including the real-time interactive scenario. The component execution platform 110 may receive the access instruction in a card corresponding to the schedule including the real-time interactive scenario, or in a schedule list in a calendar.

As shown in the example interface 202 in FIG. 2B, the component execution platform 110 presents a schedule including the real-time interactive scenario (e.g., the conference) in the form of a “participate by XX assistant” card 221. The component execution platform 110 presents a “participate by XX assistant” control on the “participate by XX assistant” card 221 to enable the user 140 to select whether to let the XX assistant participate the conference on his/her behalf.

For example, if the user 140 clicks on the “participate by XX assistant” control 222, the component execution platform 110 will receive an access instruction for the XX assistant to participate in the conference A based on the trigger of the user 140. If the user 140 clicks the “participate by XX assistant” control 223, the component execution platform 110 will receive an access instruction for the XX assistant to participate in the conference B based on the trigger of the user 140.

In some examples, the component execution platform 110 may receive an access instruction during a session between the digital assistant with the user. As shown in the example interface 201 shown in FIG. 2A, the component execution platform 110 receives an access instruction for the XX assistant to participate in the conference A based on the user 140 clicking the “participate by XX assistant” control 211.

Alternatively, or additionally, in some embodiments, the component execution platform 110 may further receive the access instruction via the prompt information for exiting the real-time interactive scenario. When the user 140 exits the conference during the conference, the component execution platform 110 will present the prompt information, which may enable the user 140 to select whether to continue to participate in the conference by the digital assistant on behalf of the user 140.

In some embodiments, the component execution platform 110 creates a target session for the real-time interactive scenario in response to the access instruction. Members of the target session include the user and the digital assistant. In some embodiments, the component execution platform 110 presents the interactive progress information of the real-time interactive scenario through the target session during the real-time interactive scenario.

In some examples, if the digital assistant accesses the real-time interactive scenario on behalf of the user, the component execution platform 110 will create the target session for the real-time interactive scenario. During the real-time scenario, the component execution platform 110 will present the interactive progress information of the real-time interactive scenario in the interface (e.g., a chat window) of the target session. As shown in the example interface 203 in FIG. 2C, during the real-time scenario, the component execution platform 110 will present the interactive progress information of the real-time interactive scenario in the interface 230 of the target session.

In some embodiments, the presenting, by the component execution platform 110, the interaction progress information of the real-time interactive scenario in the interface of the target session includes at least one of the following: historical speech content of one or more speakers in the real-time interactive scenario, real-time speech content of one or more speakers in the real-time interactive scenario, a summary of the speech content of one or more speakers in the real-time interactive scenario over a period of time, or indicative information related to an object shared in the real-time interactive scenario.

As shown in the example interface 203 shown in FIG. 2C, the component execution platform 110 presents the interactive progress information of the real-time interactive scenario in the interface 230 of the target session, including the historical speech content 231 of one or more speakers in the real-time interactive scenario. The component execution platform 110 presents the interactive progress information of the real-time interactive scenario in the interface 230 of the target session, including the real-time speaking content 232 of one or more speakers in the real-time interactive scenario. In some examples, for a summary of the stage, the summary of the stage may be a summary for the historical speech content before joining the conference, or for the speech content after joining the conference.

The interaction progress information of the real-time interactive scenario presented by the component execution platform 110 in the interface 230 of the target session includes a summary of the speech content of one or more speakers in the real-time interactive scenario over a period of time. For example, a summary of the main content and the topic of the current conference over a certain period of time, and the like. The interaction progress information of the real-time interactive scenario presented by the component execution platform 110 in the interface 230 of the target session includes indicative information 233 related to objects (e.g., screens and/or documents) shared in the real-time interactive scenario.

For ease of understanding, the interaction process of obtaining historical speech content in a real-time interactive scenario (for example, participating a conference) accessed by a digital assistant is first described below with reference to FIG. 3. FIG. 3 illustrates a schematic diagram of an example architecture 300 for obtaining historical speech content in a real-time interactive scenario by a digital assistant access real-time interactive scenario according to some embodiments of the present disclosure.

In the example architecture 300, a client 311 not accessing the scenario. a client 321 accessing the scenario with audio/video, a server 331, and a client 341 accessing the scenario by a digital assistant may be deployed on the component execution platform 110. As used herein, an “accessing the scenario with audio/video” refers to accessing the real-time interactive scenario in an audio and video mode described above, and a “accessing the scenario by the digital assistant” refers to accessing the real-time interactive scenario by the digital assistant on behalf of the user.

At block 312, the client 311 that not accessing the scenario launches the scenario. At block 313, the server 331 pushes a scenario access card in response to the client 311 not accessing the scenario launches the scenario. At block 314, the client 311 not accessing the scenario presents the scenario schedule obtained in the form of a card.

In block 315, the client 311 not accessing the scenario presents the scenario access card pushed from the server 331, or a card including the scenario schedule, and displays a “digital assistant” control on the card for the user to select whether to access the scenario by the digital assistant.

In block 316, if the user chooses not to access the scenario by the digital assistant, the client 321 accessing the scenario with audio and video will access the scenario in the form of with audio and video and send the audio and video data and initiate the shared screen/document.

In block 317, the server 331 converts the audio and video data sent by the client 321 accessing the scenario with audio and video into text data. At block 318, the server 331 stores the text data as historical text caption data for the client 341 accessing the scenario by digital assistant subsequently.

At block 319, the server 331 triggers a summary based on a preconfigured condition. For example, the server 331 summarizes the historical caption data at a regular interval and stores the summarized content. In block 320, the server 331 stores the shared screen/shared document initiated by the client 321 accessing the scenario of the audio and video.

At block 323, if the user selects to access the scenario by the digital assistant, the client 341 accessing the scenario by the digital assistant will access the scenario in the form that the digital assistant accessing the scenario on behalf of the user. In block 324, the client 341 accessing the scenario by the digital assistant receives the historical captions/summaries in the scenario based on the text captions stored by the server 331 and the criteria of triggering the summary, and then presents the historical captions/summaries in the scenario received by the client 341 in the interface of the target session.

At block 325, the client 341 accessing the scenario by the digital assistant receives information of shared screen/shared document in the scenario based on the shared screen/shared document initiated by the client 321 accessing the scenario with audio/video and stored by the server 331.

At block 322, the server 331 obtains the screenshot of current screen/document according to the information of shared screen/shared document in the scenario received by the client 341 accessing the scenario by the digital assistant. At block 326, the client 341 accessing the scenario by the digital assistant obtains the information of current screen/document based on the screenshot of current screen/document obtained by the server 331.

In this manner, the component execution platform may pull the historical record of the real-time interactive scenario when the digital assistant joins, even if the user selects to access the real-time interactive scenario by the digital assistant on behalf of the user in the middle of the conference. Therefore, the user may obtain the historical progress status of the real-time interactive scenario through the created target session.

An interaction process for obtaining real-time speech content in a real-time interactive scenario (for example, participating a conference) accessed by a digital assistant is described below with reference to FIG. 4. FIG. 4 illustrates a schematic diagram of an example architecture 400 for obtaining real-time speech content in a real-time interactive scenario accessed by the digital assistant according to some embodiments of the present disclosure.

In block 411, in a case that the scenario is accessed in the form of with audio and video, the client 321 accessing the scenario with an audio and video initiates a scenario, sends the audio and video data, initiates a shared screen/shared document, and ends the scenario. In block 412, the server 331 accesses the scenario initiated by the client 321 accessing the scenario with audio and video and pushes the scenario to the client 341 accessing the scenario by the digital assistant.

At block 413, the client 341 accessing the scenario by the digital assistant receives a scenario start notification. In block 414, the server 331 converts the audio and video data sent by the client 321 accessing the scenario with audio and video into text data. At block 415, the server 331 stores the text data as historical text caption data of the client 341 accessing the scenario by the digital assistant subsequently.

At block 416, the server 331 generates summaries based on the stored text data. For example, the server 331 summarizes the historical caption data at a regular interval with a called algorithm and stores the summarized content.

In block 417, when accessing the scenario by the digital assistant, the client 341 accessing the scenario by the digital assistant receives the historical caption/summary in the scenario based on the text caption stored by the server 331 and the summaries at regular intervals, and then presents the historical caption/summary in the scenario received by the client 341 in the interface of the target session. In some examples, the client 341 accessing the scenario by the digital assistant may cause the user to manually trigger a historical caption/summary in the scenario.

In block 418, if a target keyword/target topic is matched by the server 331 according to the stored text caption, the server 331 pushes the target keyword/target topic to the client 341 accessing the scenario by the digital assistant. For example, whether a certain agenda or a certain keyword is matched with the data converted from voice to the text is determined by the server 331. If there is a match, an alert message is sent to remind the client 341 accessing the scenario by the digital assistant. The client 341 accessing the scenario by the digital assistant may determine, according to the content, whether to directly access the scenario in the form of with audio and video.

At block 419, the client 341 accessing the scenario by the digital assistant receives a reminder of the target keyword/target topic in the scenario pushed by the server 331. In block 420, the server 331 stores the shared screen/shared document initiated by the client 321 accessing the scenario with audio and video. At block 421, the client 341 accessing the scenario by the digital assistant receives information of shared screen/shared document in the scenario based on the shared screen/shared document initiated by the client 321 accessing the scenario with audio/video and stored by the server 331.

At block 422, the server 331 obtains the screenshot of current screen/document according to the information of shared screen/shared document in the scenario received by the client 341 accessing the scenario by the digital assistant. At block 423, the client 341 accessing the scenario by the digital assistant obtains the information of current screen/document based on the screenshot of current screen/document obtained by the server 331.

In block 424, the server 331 leaves the scenario according to the ending scenario instruction initiated by the client 321 accessing the scenario with audio and video and pushes it to the client 341 accessing the scenario by the digital assistant. At block 425, the client 341 accessing the scenario by the digital assistant receives a scenario ending notification.

In this manner, on behalf of the user, the digital assistant accessing the real-time interactive scenario may help the user obtain the content of the real-time interactive scenario. After the real-time interactive scenario progresses to a certain topic, the user is reminded in time, and the user may re-join the conference with audio and video.

In some embodiments, the component execution platform 110 presents the shared object in response to detecting a trigger for the indicative information related to the shared object. For example, if the user A initiates a shared screen, the user B of the client 341 accessing the scenario by the digital assistant receives “User A initiates screen sharing”, and the screen sharing screenshot may be obtained by clicking the button “obtaining the shared screenshot”.

For another example, if the user A initiates a shared document, the user B of the client 341 accessing the scenario by the digital assistant receives “User A initiates document sharing, and the link is: XXXX”, and the user may view the document in the browser by clicking the link.

In some embodiments, the component execution platform 110 detects whether the interaction in the real-time interactive scenario satisfies a preconfigured condition. If it is detected that the interaction in the real-time interactive scenario satisfies the preconfigured condition, the component execution platform 110 presents the reminder information about the preconfigured condition being satisfied.

As shown in the example interface 204 shown in FIG. 2D, the component execution platform 110 detects that the interaction in the real-time interactive scenario satisfies the preconfigured condition, and presents, in the interface of the target session, reminder information 240 related to the preconfigured condition being satisfied. For example, contact A mentioned your name, “Contact A participated this schedule”, and so on.

In some examples, the component execution platform 110 detects that the interaction in the real-time interactive scenario satisfied the preconfigured condition, and may also present, in the form of a system pop-up window, reminder information about the preconfigured condition being satisfied. In this manner, the user may be notified to access the scenario in time in a more eye-catching and direct manner.

In some embodiments, the component execution platform 110 may present the reminder information in the form of urgent messages. As shown in the example interface 204 in FIG. 2D, the component execution platform 110 displays an urgent flag 241 on the reminder information (also sometimes referred to as “urgent message”) 240 to indicate that the reminder information is an urgent message.

In some embodiments, the component execution platform 110 presents an access control for the user to access the real-time interactive scenario in association with the reminder information. With continued reference to the example interface 204 shown in FIG. 2D, the component execution platform 110 displays an “participate by XX assistant” control 242 on the reminder information (sometimes also referred to as “urgent message”) 240 for the user to access the real-time interactive scenario. This may facilitate the user accessing the real-time interactive scenario in time.

In some examples, the component execution platform 110 presents controls for the user to review the real-time interactive scenario in association with the reminder information. As shown in the example interface 205 shown in FIG. 2E, the component execution platform 110 displays a “test schedule” control 251 on the reminder information 240 for the user to review the real-time interactive scenario.

In some embodiments, the component execution platform 110 sends reply information associated with the preconfigured condition in the real-time interactive scenario via the digital assistant according to the automatic reply setting. The component execution platform 110 sends the reply information associated with the preconfigured condition in the real-time interactive scenario via the digital assistant according to an automatic reply rule preconfigured by the user. Such reply information may be in any form, such as a voice message, a text message, or the like. The specific content of the reply information may be configured by the user, for example, the specific content of the reply information is configured when the preconfigured condition is satisfied.

For example, after receiving the reminder information, the user may directly access the real-time interactive scenario in the form of with audio and video or send a voice/text message to the user of the client accessing the scenario with audio and video. The user may also configure an automatic reply rule when accessing the real-time interactive scenario, and automatically send the voice/text message to the user of the client accessing the scenario with audio and video after a certain agenda is triggered.

For ease of understanding, the following reference FIG. 5 continues to describe how the component execution platform 110 detects whether the interaction in the real-time interactive scenario satisfies a preconfigured condition. In some embodiments, the preconfigured condition includes at least one of the following: the interactive content in the real-time interactive scenario includes a target keyword, or the interactive topic in the real-time interactive scenario includes a target topic. In some examples, the target keyword may be configured by the user or may be a name of the user by default.

In some embodiments, the component execution platform 110 obtains a first text that corresponds to speech content of one or more speakers in a real-time interactive scenario. Then, the component execution platform 110 detects whether the first text includes a word matching the target keyword. If the component execution platform 110 does not detect the matching word, the first text is converted to the second text. The first text and the second text are, for example, different types of text. If the component execution platform 110 detects the word matching the keyword in the text of the second format, it is determined that the interaction in the real-time interactive scenario satisfies the preconfigured condition.

In some embodiments, the first text and the second text may be texts of different formats, for example, the first text is with a first format, and the second text is with a second format different from the first format. The component execution platform 110 obtains the text in the first format. The text in the first format corresponds to speech content of one or more speakers in the real-time interactive scenario, and the target keyword is with the first format. The text of the first format obtained by the component execution platform 110 instructs the server 331 to convert the audio and video data sent by the client 321 accessing the scene with audio and video to text. Then, the component execution platform 110 detects whether the text in the first format includes a word matching the target keyword.

If the component execution platform 110 does not detect the matching word, the text of the first format and the target keyword are respectively converted to the text of the second format and the keyword of the second format. If the component execution platform 110 detects the word matching the keyword of the second format in the text of the second format, it is determined that the interaction in the real-time interactive scenario satisfies the preconfigured condition. In some examples, the text of the second format determined by the component execution platform 110 instructs the server 331 to convert the text of the first format to Pinyin.

For example, the component execution platform 110 performs regular matching through text. If a keyword configured by the user of the client 341 accessing the scenario by the digital assistant is matched, the component execution platform 110 sends an urgent reminder message for keyword to the user of the client 341 accessing the scenario by the digital assistant. If the there is no match of the text, a regular matching for Pinyin is performed. If a keyword configured by the user of the client 341 accessing the scenario by the digital assistant is matched, the component execution platform 110 sends an urgent reminder message for keyword to the user of the client 341 accessing the scenario by the digital assistant.

In this embodiment, by performing keyword and matching detection in different types of text (for example, different formats), accuracy and hit rate of keyword detection may be improved. In this manner, it may be ensured that the keywords configured by the user may be timely and accurately reminded. In particular, the first text in the real-time interactive scenario is usually text obtained by recognizing the audio of the speaker. The second text (e.g., pinyin) may be more matched to the speech of the speaker than the first text (e.g., text). In this case, the conversion of different types of text is more important for improving the accuracy and hit rate.

In some embodiments, the component execution platform 110 detects, using a first model, whether speech content of one or more speakers in the real-time interactive scenario matches the target topic. If the component execution platform 110 does not detect that the speech content matches the target topic, a second model is used to detect whether the speech content matches the target topic. The quantity of parameters of the second model is greater than that of the first model. Therefore, the first model may be considered as a small model or a simple model, and the second model may be considered as a complex model. If the component execution platform 110 detects that the speech content matches the target topic using the second model, it is determined that the interaction in the real-time interactive scenario satisfies the preconfigured condition.

In some examples, if no match is detected for the pinyin, the component execution platform 110 performs intent recognition using a small model such as the first model. If an agenda configured by the user of the client 341 accessing the scenario by the digital assistant is matched, the component execution platform 110 sends an alert message for the agenda to the user of the client 341 accessing the scenario by the digital assistant.

If no match is detected by the first model and other small models, more complex models are invoked for intent recognition. If the agenda configured by the user of the client 341 accessing the scenario by the digital assistant is matched, the component execution platform 110 sends an alert message for the agenda to the user of the client 341 accessing the scenario by the digital assistant.

In such embodiments, a simple model and a complex model are combined to detect topics. On one hand, increase of computation and consumed time may be avoided, and on the other hand, the detection accuracy may be improved.

FIG. 5 illustrates a schematic diagram of an example architecture 500 for detecting whether an interaction in a real-time interactive scenario satisfies a preconfigured condition according to some embodiments of the present disclosure.

At block 511, the client 341 accessing the scenario by the digital assistant accesses the scenario in the form of accessing the scenario by the digital assistant. At this time, the user may configure the target keyword/target topic to trigger the reminder when accessing the real-time interactive scenario. In block 512, the server 331 stores the target keyword/target topic configured by the user and triggers the reminder processing mode.

In block 513, when the scenario is accessed in the form of with audio and video, the audio and video data is sent by the client 321 accessing the scenario with audio and video. In block 514, the server 331 converts the audio and video data sent by the client 321 accessing the scenario with audio and video to text data. At block 515, the server 331 converts the text data to pinyin data.

At block 516, the server 331 determines whether the text data matches a target keyword configured by a user of the client 341 accessing the scenario by the digital assistant. At block 517, if the server 331 detects a match, the client 341 accessing the scenario by the digital assistant receives reminder information regarding the keyword.

At block 518, if the server 331 does not detect a match in the text data, it is determined whether the pinyin matches the target keyword. At block 519, if the server 331 detects a match, the client 341 accessing the scenario by the digital assistant receives reminder information regarding the keyword.

In block 520, if the server 331 does not detect a match in the pinyin, the intention recognition is continued to use the small model, and whether the target topic is matched (sometimes referred to as “agenda”) is determined. At block 521, if the server 331 detects a match, the client 341 accessing the scenario by the digital assistant receives reminder information regarding the target topic.

In block 522, if the server 331 does not detect a match based on the small model, the invoke of the large model for intent recognition is continued to and determining whether to the target topic is matched. At block 523, if the server 331 detects a match, the client 341 accessing the scenario by the digital assistant receives reminder information regarding the target topic.

At block 524, the client 341 accessing the scenario by the digital assistant may provide the user with a corresponding control of the “participate by the digital assistant” for the user to select whether to access the real-time interactive scenario. In block 525, after receiving the reminder information, the user may directly access the real-time interactive scenario in the form of with audio and video.

At block 526, the client 341 accessing the scenario by the digital assistant may provide the user with a corresponding control for “send text/speech” for the user to select whether to send text/speech to the user of the client accessing the scenario with audio/video. In block 527, after receiving the reminder information, the user may also send a voice/text message to the user of the client accessing the scenario with audio/video.

By configuring keywords/topics by the user, the user may be reminded when the conference mentioned these keywords or progresses to the topic. Further, the use the model(s) may improve the signal-to-noise ratio of the participance and summarize the content of the conference in segments and \ send the refined content to the user. Correspondingly, whether to progress to a certain topic or mention a certain keyword may be accurately determined by calling the model(s), and then send the reminding information the user in time.

In summary, the user may enter the real-time interactive scenario without audio and video and obtain the interaction progress information in real time. A history of the real-time interactive scenario may be pulled upon the joining of the digital assistant. Further, the user may be assisted in understanding the content of the real-time interactive scenario, the user is reminded in time in response to the real-time interactive scenario progresses to a certain topic, and the user may re-join the conference with audio and video.

### Example Processes, Apparatus, and Apparatus

FIG. 6 shows a flowchart of a process 600 for information interaction according to some embodiments of the present disclosure. Process 600 may be implemented at the component execution platform 110. The process 600 is described below with reference to FIG. 1.

At block 610, the component execution platform 110 receives an access instruction for the digital assistant to access a real-time interactive scenario on behalf of a user.

At block 620, the component execution platform 110 creates a target session for the real-time interactive scenario in response to the access instruction, members of the target session including the user and the digital assistant.

In block 630, the component execution platform 110 presents the interactive progress information of the real-time interactive scenario through the target session during the real-time interactive scenario.

In some embodiments, the interaction progress information includes at least one of: historical speech content of one or more speakers in the real-time interactive scenario, real-time speech content of one or more speakers in the real-time interactive scenario, a summary of the speech content of one or more speakers in the real-time interactive scenario over a period of time, or indicative information related to an object shared in the real-time interactive scenario.

In some embodiments, the process 600 further includes presenting the shared object in response to detecting a trigger for the indicative information.

In some embodiments, the process 600 further includes: detecting whether an interaction in the real-time interactive scenario satisfies a preconfigured condition; and in response to detecting that the interaction in the real-time interactive scenario satisfies the preconfigured condition, presenting the reminder information about the preconfigured condition being satisfied.

In some embodiments, the reminder information is presented in an urgent message mode.

In some embodiments, the process 600 further includes presenting an access control for the user to access the real-time interactive scenario in association with the reminder information.

In some embodiments, the preconfigured condition includes at least one of the following: the interactive content in the real-time interactive scenario includes a target keyword, or the interactive topic in the real-time interactive scenario includes a target topic.

In some embodiments, detecting whether the interaction in the real-time interactive scenario satisfies the preconfigured condition includes: obtaining first text, the first text corresponding to speech content of one or more speakers in the real-time interactive scenario; detecting whether the first text includes a matching word of the target keyword; in response to the matching word being not detected, converting the first text to second text; and in response to detecting the matching word of the keyword in the second text, determining that the interaction in the real-time interactive scenario satisfies the preconfigured condition.

In some embodiments, detecting whether the interaction in the real-time interactive scenario satisfies the preconfigured condition includes: detecting, using a first model, whether the speech content of one or more speakers in the real-time interactive scenario matches the target topic; in response to not detecting that the speech content matches the target topic, detecting, using a second model, whether the speech content matches the target topic, and the quantity of parameters of the second model is greater than that of the first model; in response to detecting that the speech content matches the target topic using the second model, determining that the interaction in the real-time interactive scenario satisfies the preconfigured condition.

In some embodiments, the process 600 further includes: sending, by the digital assistant, reply information associated with the preconfigured condition in the real-time interactive scenario based on an automatic reply setting.

In some embodiments, the access instruction is received via at least one of: a start message for the real-time interactive scenario, an access invitation message for the real-time interactive scenario, a schedule including the real-time interactive scenario, or a prompt message for exiting the real-time interactive scenario.

FIG. 7 is a schematic structural block diagram of an information interaction apparatus 700 according to some embodiments of the present disclosure. The apparatus 700 may be implemented or included on the component execution platform 110. The various modules/components in the apparatus 700 may be implemented by hardware, software, firmware, or any combination thereof.

As shown in the figure, the apparatus 700 includes an instruction receiving module 710 configured to receive, by the component execution platform 110, an access instruction for the digital assistant to access a real-time interactive scenario on behalf of a user. The apparatus 700 further includes a session creation module 720 configured to, in response to the access instruction, create a target session for the real-time interactive scenario, where the members of the target session include the user and the digital assistant. The apparatus 700 further includes an information presenting module 730 configured to present, by the component execution platform 110, the interactive progress information of the real-time interactive scenario through the target session during the real-time interactive scenario.

In some embodiments, the interaction progress information includes at least one of: historical speech content of one or more speakers in the real-time interactive scenario, real-time speech content of one or more speakers in the real-time interactive scenario, a summary of the speech content of one or more speakers in the real-time interactive scenario over a period of time, or indicative information related to an object shared in the real-time interactive scenario.

In some embodiments, the apparatus 700 further includes an object presentation module configured to present a shared object in response to detecting a trigger for the indicative information.

In some embodiments, the apparatus 700 further includes a reminder information presenting module configured to detect whether an interaction in the real-time interactive scenario satisfies a preconfigured condition; and in response to detecting that the interaction in the real-time interactive scenario satisfies the preconfigured condition, present the reminder information that the preconfigured condition is satisfied.

In some embodiments, the reminder information is presented in an urgent message mode.

In some embodiments, the apparatus 700 further includes a control presentation module configured to present an access control for the user to access the real-time interactive scenario in association with the reminder information.

In some embodiments, the preconfigured condition includes at least one of the following: the interactive content in the real-time interactive scenario includes a target keyword, or the interactive topic in the real-time interactive scenario includes a target topic.

In some embodiments, the prompt information presentation module includes a condition detection module configured to obtain first text, where the first text corresponds to speech content of one or more speakers in the real-time interactive scenario; detect whether the first text includes a matching word of the target keyword; in response to the matching word not being detected, convert the first text to second text; and in response to detecting the matching word of the keyword in the second text, determine that the interaction in the real-time interactive scenario satisfies the preconfigured condition.

In some embodiments, the condition detection module is further configured to: detect, using a first model, whether speech content of the one or more speakers in the real-time interactive scenario matches the target topic; in response to not detecting that the speech content matches the target topic, detect, using a second model, whether the speech content matches the target topic, where the quantity of parameters of the second model is greater than that of the first model; and in response to detecting that the speech content matches the target topic using the second model, determine that the interaction in the real-time interactive scenario satisfies the preconfigured condition.

In some embodiments, the apparatus 700 further includes a control presentation module configured to, based on an automatic reply setting, send, by the digital assistant, reply information associated with the preconfigured condition in the real-time interactive scenario.

In some embodiments, the access instruction is received via at least one of: a start message for the real-time interactive scenario, an access invitation message for the real-time interactive scenario, a schedule including the real-time interactive scenario, or a prompt message for exiting the real-time interactive scenario.

FIG. 8 shows a block diagram illustrating an electronic device 800 in which one or more embodiments of the present disclosure may be implemented. It should be understood that the electronic device 800 illustrated in FIG. 8 is merely exemplary and should not constitute any limitation on the functionality and scope of the embodiments described herein. The electronic device 800 shown in FIG. 8 may be configured to implement the component execution platform 110 in FIG. 1.

As shown in FIG. 8, the electronic device 800 is in the form of a general-purpose electronic device. Components of the electronic device 800 may include, but are not limited to, one or more processors or processing units 810, a memory 820, a storage device 830, one or more communication units 840, one or more input devices 850, and one or more output devices 860. The processing unit 810 may be an actual or virtual processor and capable of performing various processes according to programs stored in the memory 820. In multiprocessor systems, multiple processing units execute computer-executable instructions in parallel to improve parallel processing capabilities of electronic device 800.

Electronic device 800 typically includes a plurality of computer storage media. Such media may be any available media accessible to the electronic device 800, including, but not limited to, volatile and non-volatile media, removable and non-removable media. The memory 820 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 830 may be a removable or non-removable medium and may include a machine-readable medium, such as a flash drive, magnetic disk, or any other medium, which may be capable of storing information and/or data and may be accessed within electronic device 800.

The electronic device 800 may further include additional removable/non-removable, volatile/non-volatile storage media. Although not shown in FIG. 8, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 820 may include a computer program product 825 having one or more program modules configured to perform various methods or actions of various embodiments of the present disclosure.

The communication unit 840 is configured to communicate with another electronic device through a communication medium. Additionally, the functionality of components of the electronic device 800 may be implemented in a single computing cluster or multiple computing machines capable of communicating over a communication connection. Thus, the electronic device 800 may operate in a networked environment using logical connections with one or more other servers, network personal computers (PCs), or another network node.

The input device 850 may be one or more input devices, such as a mouse, a keyboard, a trackball, or the like. The output device 860 may be one or more output devices, such as a display, a speaker, a printer, or the like. The electronic device 800 may also communicate with one or more external devices (not shown) through the communication unit 840 as needed, external devices such as storage devices, display devices, etc., communicate with one or more devices that enable a user to interact with the electronic device 800, or communicate with any device (e.g., a network card, a modem, etc.) that enables the electronic device 800 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general-purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

I/We claim:

1. A method for information interaction comprising:
receiving an access instruction for a digital assistant to access a real-time interactive scenario on behalf of a user;
creating, in response to the access instruction, a target session for the real-time interactive scenario, members of the target session comprising the user and the digital assistant; and
presenting, during the real-time interactive scenario, interaction progress information of the real-time interactive scenario through the target session.

2. The method of claim 1, wherein the interaction progress information comprises at least one of:
historical speech content of one or more speakers in the real-time interactive scenario,
real-time speech content of one or more speakers in the real-time interactive scenario,
a summary of the speech content of one or more speakers in the real-time interactive scenario over a period of time, or
indicative information related to an object shared in the real-time interactive scenario.

3. The method of claim 2, further comprising:
in response to detecting a trigger for the indicative information, presenting the shared object.

4. The method of claim 1, further comprising:
detecting whether an interaction in the real-time interactive scenario satisfies a preconfigured condition; and
presenting, in response to detecting that the interaction in the real-time interactive scenario satisfies the preconfigured condition, reminder information that the preconfigured condition is satisfied.

5. The method of claim 4, wherein the reminder information is presented in an urgent message mode.

6. The method of claim 4, further comprising:
presenting, in association with the reminder information, an access control for the user to access the real-time interactive scenario.

7. The method of claim 4, wherein the preconfigured condition comprises at least one of:
an interactive content in the real-time interactive scenario comprises a target keyword, or
an interactive topic in the real-time interactive scenario comprises a target topic.

8. The method of claim 7, wherein detecting whether the interaction in the real-time interactive scenario satisfies the preconfigured condition comprises:
obtaining first text corresponding to speech content of one or more speakers in the real-time interactive scenario;
detecting whether the first text comprises a matching word of the target keyword; and
determining that the interaction in the real-time interactive scenario satisfies the preconfigured condition in response to the first text comprising the matching word of the target keyword.

9. The method of claim 8, further comprising:
converting the first text to second text in response to not detecting the matching word; and
determining that the interaction in the real-time interactive scenario satisfies the preconfigured condition in response to detecting a matching word of the target keyword in the second text.

10. The method of claim 7, wherein detecting whether the interaction in the real-time interactive scenario satisfies the preconfigured condition comprises:
detecting, using a first model, whether speech content of one or more speakers in the real-time interactive scenario matches the target topic; and
determining that the interaction in the real-time interactive scenario satisfies the preconfigured condition in response to detecting that the speech content matches the target topic.

11. The method of claim 10, further comprising:
in response to not detecting that the speech content matches the target topic, detecting, using a second model, whether the speech content matches the target topic, the quantity of parameters of the second model being greater than that of the first model; and
in response to detecting that the speech content matches the target topic using the second model, determining that the interaction in the real-time interactive scenario satisfies the preconfigured condition.

12. The method of claim 4, further comprising:
sending, by the digital assistant, reply information associated with the preconfigured condition in the real-time interactive scenario based on an automatic reply setting.

13. The method of claim 1, wherein the access instruction is received via at least one of:
a start message for the real-time interactive scenario,
an access invitation message for the real-time interactive scenario,
a schedule comprising the real-time interactive scenario; or
a prompt message for exiting the real-time interactive scenario.

14. An electronic device comprising:
at least one processing unit; and
at least one memory coupled to the at least one processing unit and storing instructions for execution by the at least one processing unit, the instructions, when executed by the at least one processing unit, causing the electronic device to perform a method for information interaction, comprising:
receiving an access instruction for a digital assistant to access a real-time interactive scenario on behalf of a user;
creating, in response to the access instruction, a target session for the real-time interactive scenario, members of the target session comprising the user and the digital assistant; and
presenting, during the real-time interactive scenario, interaction progress information of the real-time interactive scenario through the target session.

15. The electronic device of claim 14, wherein the interaction progress information comprises at least one of:
historical speech content of one or more speakers in the real-time interactive scenario,
real-time speech content of one or more speakers in the real-time interactive scenario,
a summary of the speech content of one or more speakers in the real-time interactive scenario over a period of time, or
indicative information related to an object shared in the real-time interactive scenario.

16. The electronic device of claim 15, further comprising:
in response to detecting a trigger for the indicative information, presenting the shared object.

17. The electronic device of claim 14, further comprising:
detecting whether an interaction in the real-time interactive scenario satisfies a preconfigured condition; and
presenting, in response to detecting that the interaction in the real-time interactive scenario satisfies the preconfigured condition, reminder information that the preconfigured condition is satisfied.

18. The electronic device of claim 17, wherein the reminder information is presented in an urgent message mode.

19. The electronic device of claim 17, further comprising:
presenting, in association with the reminder information, an access control for the user to access the real-time interactive scenario.

20. A non-transitory computer-readable storage medium having stored thereon a computer program executable by a processor to implement a method
for information interaction, comprising:
receiving an access instruction for a digital assistant to access a real-time interactive scenario on behalf of a user;
creating, in response to the access instruction, a target session for the real-time interactive scenario, members of the target session comprising the user and the digital assistant; and
presenting, during the real-time interactive scenario, interaction progress information of the real-time interactive scenario through the target session.
